(19) United States
(12) Patent Application Publication
(10) Pub. No.: US 2006/0028035 A1
(43) Pub. Date: Feb. 9, 2006

(54) Bumper-supporting structure of a motor vehicle

(76) Inventors: Michael Bechtold, Moensheim (DE); Achim Kurz-Ritter Von Sporschill, Remshalden (DE); Klaus-Erik Schmid, Kirchheim (DE); Gregor Steinmetz, Stuttgart (DE); Martin Tebbe, Tuebingen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/518,913

(22) PCT Filed: May 15, 2003
(86) PCT No.: PCT/EP03/05096

§ 371 Date: Jul. 27, 2005

(30) Foreign Application Priority Data
Jun. 28, 2002 (DE) 102 29 606.6

(51) Int. Cl. B60R 19/22

(52) U.S. Cl. 293/109

(57) ABSTRACT

A supporting structure for a motor vehicle, in particular an automobile, has a longitudinal beam arrangement, to at least one longitudinal end of which a bumper arrangement is attached, which has a crossbeam and a bending beam attached to the ends of the crossbeam. The crossbeam should rest in an axial direction against the longitudinal beam arrangement by way of two longitudinal beam parts, the longitudinal beam parts being attached to a central section of the crossbeam which is located at a distance from the ends.

### BACKGROUND AND SUMMARY OF THE INVENTION

This invention relates to a supporting structure for a motor vehicle, in particular for an automobile.

A supporting structure of the aforementioned type is disclosed, for example, by European publication EP 0 434 240 B1 and has a longitudinal beam arrangement with two horizontally spaced longitudinal beams running parallel to one another in the longitudinal direction of the vehicle, the longitudinal beams in the known supporting structure being arranged relatively far outwards, that is to say along the outside of the vehicle. A bumper arrangement, which from the outside inwards has a bumper cladding, a bending beam and a crossbeam, is fitted to a front or rear longitudinal end of the longitudinal beam arrangement. The bending beam is curved convexly outwards or curved concavely in relation to the crossbeam. The bending beam is attached to the lateral ends of the crossbeam. The crossbeam is in turn attached by its lateral ends to axial ends of the two longitudinal beams of the longitudinal beam arrangement. Energy-absorbing foam bodies may be arranged between the bumper cladding and the bending beam, in the area of the lateral ends of the bending beam.

German document DE 31 25 650 C2 discloses a bumper arrangement, which has a bending beam resting on vehicle longitudinal beams and, at a distance from the beam, an additional bending beam arranged forward thereof and secured in relation to the bending beam. On the outside, the additional bending beam carries a bumper cladding and, on the inside, the beam carries an energy-absorbing foam body, which is arranged on the additional bending beam so that there is a gap between the bending beam and the foam body in the longitudinal direction of the vehicle. It is not apparent from this document how the bending beam is fitted to the longitudinal beams.

German document DE 36 39 195 A1 shows a further bumper arrangement having a crossbeam, a bending beam and a bumper cladding. The crossbeam is attached to front longitudinal beams of a longitudinal beam arrangement of the vehicle. In the area in which the crossbeam is attached to the longitudinal beams, the bending beam is also attached to the crossbeam. The bumper cladding is in turn fitted to the bending beam. In this embodiment, also, an energy-absorbing foam body is arranged between the bending beam and the crossbeam.

German document DE 42 23 948 C2 shows a longitudinal beam arrangement comprising two horizontally spaced longitudinal beams running parallel to one another, on the axial ends of which a crossbeam is flange-mounted. As an axial extension of the longitudinal beams, impact absorbers, by way of which a bending beam arranged forward of the crossbeam rests on the crossbeam, are attached to the crossbeam.

A common feature of the known supporting structures therefore is that the bending beam is in each case supported at the points on the crossbeam where the longitudinal beams of the longitudinal beam arrangement are also supported on the crossbeam. As a result, force is transmitted between bending beam and longitudinal beam structure with the greatest possible flexural rigidity.

In a vehicle in which the longitudinal beam arrangement is arranged approximately in the center of the vehicle (cf. German patent DE 883 846, for example), even under relatively small stresses acting on the laterally outer ends of the bending beam, such a construction leads to permanent deformations, that is to say damaging of the bending beam and/or the crossbeam. It is, however, desirable that certain, in particular standardized admissible stress loads, so-called “pendulum impacts” should not leave any lasting damage to the vehicle. This is necessary, for example, in order to meet legal standards and/or in order to achieve a low automobile insurance group classification.

An object of the present invention, therefore, is to specify an embodiment for a supporting structure of the aforementioned type, which in a vehicle having a centrally arranged longitudinal beam arrangement reduces the risk of permanent damage of the bumper arrangement under smaller, admissible stress loads.

According to the invention this object is achieved by a supporting structure having the claimed features. Advantageous embodiments form the subject matter of the dependent claims.

The invention is based on the general idea, on the one hand, of connecting the crossbeam at its lateral, outer ends to the bending beam and, on the other, of supporting it, in a central section between its ends, on the longitudinal beam arrangement by way of two longitudinal beam parts in the longitudinal direction of the vehicle. In this case the bending beam is attached to the crossbeam only in the area of its lateral ends. This design construction permits relative movements of the crossbeam and bending beam between the ends of the crossbeam, which in the event of a bending stress on the crossbeam, directed away from the bending beam and acting on one of the ends of the crossbeam, leads to tensile stressing of the bending beam, thereby increasing the rigidity of the arrangement. As a result, relatively large forces can be applied without permanent deformations of the bumper arrangement occurring. It has furthermore been shown that even a centrally acting stress can be particularly well supported without damage, since under such a stress the bending beam comes to bear on the crossbeam within the elastic range of the former, the crossbeam in turn being supported on the longitudinal beam arrangement by way of the longitudinal beam parts in proximity to the point of application of the force and in the direction thereof. Accordingly, here too, relatively high forces can be absorbed without damage.

According to a preferred embodiment the bending beam, at least in the central section where the longitudinal beam parts rest on the crossbeam, may rest on the crossbeam by way of at least one energy-absorbing foam body. This measure serves to damp the relative movements between the bending beam and the crossbeam, thereby improving the protective effect afforded to persons by the bumper arrangement.

In another development the longitudinal beam parts, at their ends remote from the crossbeam, may be attached by way of a bearing bracket to one another and to the longitudinal beam arrangement. This bracket may form a type of interface for the attachment of the bumper arrangement to the longitudinal beam arrangement. The bracket may furthermore be designed as a so-called “crash element”, in order to exercise an energy-absorbing effect in the event of a crash.

Further important features and advantages of the invention will be apparent from the subordinate claims, from the drawings and from the associated description of the figures referring to the drawings.

It will be appreciated that the features specified above and still to be explained below can be utilized not only in the particular combination specified but also in other combinations or alone, without departing from the scope of the present invention.

A preferred exemplary embodiment of the invention is represented in the drawing and will be explained in more detail in the following description, the same reference numerals being used to denote identical or functionally equivalent or similar components.

### BRIEF DESCRIPTION OF THE DRAWINGS

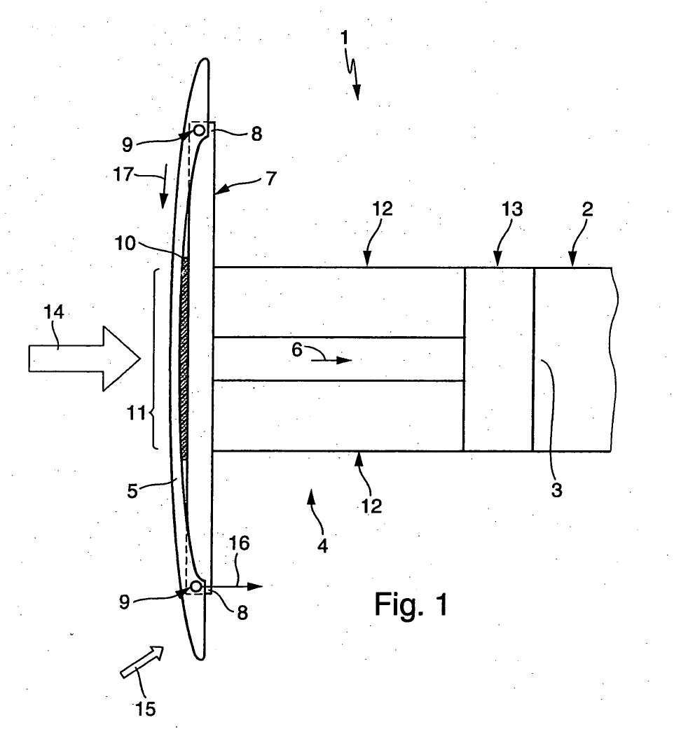

The only FIG., FIG. 1, shows a highly schematic view of an end section of a supporting structure according to the invention.

### DETAILED DESCRIPTION OF THE INVENTION

According to FIG. 1 an inventive supporting structure 1 for a motor vehicle, in particular an automobile, has a longitudinal beam arrangement 2, which is arranged approximately centrally in respect of the vehicle. This means, in particular, that the longitudinal beam arrangement 2 does not have any longitudinal beams running in the area of the outside of the vehicle, in particular in the door sill area. At a longitudinal end 3 shown here, which is preferably assigned to the rear end of the vehicle, the longitudinal beam arrangement 2 supports a bumper arrangement 4. This bumper arrangement 4, which preferably takes the form of a rear bumper arrangement, has a bending beam 5 which is remote from the longitudinal beam arrangement 2 and which extends essentially transversely to a longitudinal direction of the vehicle, the longitudinal direction of the vehicle or the direction of travel being symbolized in FIG. 1 by an arrow 6.

On its inner side facing the longitudinal beam arrangement 2 the bending beam 5 is attached to a crossbeam 7. This attachment is made in the area of each of the lateral ends 8 of the crossbeam 7, an embodiment being preferred in which the attachment is made in such a way that the bending beam 5 is supported on the crossbeam 7 in the area of each of the attachments (denoted by 9) such that it can rotate about a vertical axis. These axes of rotation here run perpendicular to the drawing plane. On its outer side remote from the longitudinal beam arrangement 2, the bending beam 5 may also support a bumper cladding, not represented here. The bending beam 5 preferably has a slightly convex outward curvature or is concavely shaped facing the crossbeam 7, whereas the crossbeam 7 is of relatively rectilinear design, so that at least between the attachment points 9 there is a distance between the bending beam 5 and the crossbeam 7 in the vehicle longitudinal direction 6.

In an especially preferred embodiment an energy-absorbing foam body 10, by way of which the bending beam 5 rests on the crossbeam 7 in the direction of travel 6, may be arranged between the bending beam 5 and the crossbeam 7.

Between its ends 8 the crossbeam 7 has a central section 11, identified by a brace, in which two longitudinal beam parts 12 are attached to the crossbeam 7 on a side remote from the bending beam 5. As will be apparent from FIG. 1, the central section 11 of the crossbeam 7 extends over approximately a third of the overall length of the crossbeam 7, running transversely to the vehicle longitudinal direction 6. The longitudinal beam parts 12 preferably run parallel to one another and parallel to the vehicle longitudinal direction 6. In addition, the two longitudinal beam parts 12 are suitably arranged side by side and at a distance from one another in a horizontal direction. In the embodiment shown here the two longitudinal beam parts 12 are supported in the vehicle longitudinal direction 6 by way of a bearing bracket 13, that is to say indirectly, on the longitudinal beam arrangement 2. The two longitudinal beam parts 12 are also attached to one another by way of this bearing bracket 13. The bearing bracket 13 is suitably designed as crash element. The bearing bracket 13 furthermore facilitates a modular construction of the bumper arrangement 4, which can be fully preassembled and can be connected to the longitudinal beam arrangement 2 via the bearing bracket 13 designed as interface.

The supporting structure 1 functions as follows:

In the event of a central force 14 running parallel to the vehicle longitudinal direction 6 and acting centrally on the bending beam 5, and symbolized by an arrow in FIG. 1, the bending beam 5 is first subjected to a bending stress. This results in a relative movement of the bending beam 5 in relation to the crossbeam 7, in which the bending beam 5 comes closer to the crossbeam 7. If the foam body 10 is arranged between the bending beam 5 and the crossbeam 7, energy will already be absorbed during this convergence. Here the force transmitted in the area of the outer ends 8 of the crossbeam 7 is relatively small. The greater part of the forces being transmitted between the bending beam 5 and the crossbeam 7 is transmitted centrally in the area where the force is introduced, either via the intervening foam body 10 or at the latest when the bending beam 5, due to its bending deformation, comes to bear on the crossbeam 7. Since this central force 14 acts in the central section 11 of the crossbeam 7, it can be supported on the longitudinal beam arrangement 2 relatively directly via the longitudinal beam parts 12 and the bearing bracket 13. The high rigidity of the bumper arrangement 4 in the central section 11 of the crossbeam 7 means that permanent deformations under relatively high, admissible untoward forces can be prevented.

If a corner force 15, symbolized by an arrow, acts on the bending beam 5 in the area of a lateral end 8, this force is initially transmitted directly to the crossbeam 7 by way of the attachment point 9, with the result that the crossbeam is subjected to bending stress in the direction of an arrow 16. This bending stress acting on the crossbeam 7 results in a stretching of the bending beam 5, so that this is subjected to tensile stress according to an arrow 17. If the foam body 10 is arranged between the bending beam 5 and the crossbeam 7, the stretching movement of the bending beam 5 is also damped, absorbing energy, since, as it is stretched, the bending beam 5 draws closer to the crossbeam 7. The shape of the bending beam 5 selected here, with a relatively small curvature in relation to the crossbeam 7, means that a progressive increase in the tensile stress 17 in the bending beam 5 can be achieved for the bending deformation of the crossbeam 7, thereby giving the crossbeam 7 relatively high rigidity values, so that even relatively high admissible corner forces 15 can be absorbed without damage. The corner force 15 on the longitudinal beam arrangement 2 is again in this case supported by way of the longitudinal beam parts 12 and the bearing bracket 13.

It is of particular importance here that the bending beam 5 be fixed to the crossbeam 7 exclusively in the area of the lateral ends 8 of the crossbeam 7, whilst, between these attachment points 9, the bending beam 5 is capable of moving in relation to the crossbeam 7. This also applies in particular where the foam body 10 is arranged between the bending beam 5 and the crossbeam 7.

1-5. (canceled)

6. A supporting structure for a motor vehicle, in particular an automobile, comprising:
a longitudinal beam arrangement, and
a bumper arrangement attached to at least one longitudinal end of the longitudinal beam arrangement, the bumper arrangement having a crossbeam which, in an axial direction, rests against the longitudinal beam arrangement by way of two longitudinal beam parts,
wherein the longitudinal beam parts are attached to a central section of the crossbeam which is located at a distance from ends of the crossbeam,
wherein the longitudinal beam parts, at their ends remote from the crossbeam, are attached by way of a bearing bracket to one another and to the longitudinal beam arrangement,
wherein the bearing bracket is a crash element, which exercises an energy-absorbing effect in the event of a crash,
wherein the bumper arrangement has a bending beam attached to the ends of the crossbeam, and
wherein the bending beam, at least in the central section, rests on the crossbeam by way of at least one energy-absorbing foam body.

7. The supporting structure as claimed in claim 6, wherein the longitudinal beam parts run parallel to a longitudinal direction of the vehicle and at a distance from one another in a horizontal direction.

8. The supporting structure as claimed in claim 6, wherein the longitudinal beam arrangement is arranged essentially in the center of the vehicle.

9. The supporting structure as claimed in claim 6, wherein the bending beam is supported at its ends on the crossbeam such that it can rotate about vertical axes.

10. The supporting structure as claimed in claim 6, wherein the bending beam is attached exclusively at its ends to the crossbeam.

11. The supporting structure as claimed in claim 7, wherein the longitudinal beam arrangement is arranged essentially in the center of the vehicle.

12. The supporting structure as claimed in claim 7, wherein the bending beam is supported at its ends on the crossbeam such that it can rotate about vertical axes.

13. The supporting structure as claimed in claim 7, wherein the bending beam is attached exclusively at its ends to the crossbeam.

14. The supporting structure as claimed in claim 8, wherein the bending beam is supported at its ends on the crossbeam such that it can rotate about vertical axes.

15. The supporting structure as claimed in claim 8, wherein the bending beam is attached exclusively at its ends to the crossbeam.

16. The supporting structure as claimed in claim 9, wherein the bending beam is attached exclusively at its ends to the crossbeam.

17. The supporting structure as claimed in claim 11, wherein the bending beam is supported at its ends on the crossbeam such that it can rotate about vertical axes.

18. The supporting structure as claimed in claim 11, wherein the bending beam is attached exclusively at its ends to the crossbeam.

19. The supporting structure as claimed in claim 14, wherein the bending beam is attached exclusively at its ends to the crossbeam.

20. The supporting structure as claimed in claim 17, wherein the bending beam is attached exclusively at its ends to the crossbeam.
